(19) United States
(12) Patent Application Publication
(10) Pub. No.: US 2007/0024755 A1
(43) Pub. Date: Feb. 1, 2007

(54) Broadcasting receiver

(75) Inventor: Hiroshi Nishigaki, Daito-shi (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Daito-shi (JP)

(21) Appl. No.: 11/491,193

(22) Filed: Jul. 24, 2006

(30) Foreign Application Priority Data
Jul. 26, 2005 (JP) JP 2005-215648

(51) Int. Cl. H04N 5/50

(52) U.S. Cl. 348/570

(57) ABSTRACT

A broadcasting receiver of the present invention includes a tuning section and a control section. The tuning section receives a broadcasting signal corresponding to a selected channel. The control section selects a channel selected when the power was turned off most recently when the power is turned on, and displays a plurality of measures to be taken when there is no broadcasting signal on the selected channel.

### CROSS-REFERENCE TO RELATED APPLICATIONS

This application claims priority to Japanese Patent Application No. 2005-215648. The entire disclosure of Japanese Patent Application No. 2005-215648 is hereby incorporated herein by reference.

### BACKGROUND OF THE INVENTION

1. Field of the Invention

The present invention generally relates to a broadcasting receiver. More specifically, the present invention relates to a broadcasting receiver for receiving a broadcasting signal.

2. Background Information

With a conventional broadcasting receiver such as a television receiver, an antenna terminal is first connected to an antenna plug after purchase. With a power cord being inserted into a power plug, a power switch is turned on. Then, a channel preset process is performed by selecting an auto preset function, and only channels which can be received are stored in a memory. In this way, when a user pushes a channel up/down key of a remote control, channels with no broadcasting signal are skipped. Only channels having broadcasting signals are sequentially selected and displayed on a monitor screen.

When setting channels by using such an auto preset function is performed when a certain channel is not in the broadcasting time, there is a problem that such a channel is regarded as a channel with no broadcasting signal. For avoiding such a problem, if the receiver is structured to perform a process for storing a new channel, which is determined that there is a signal, in addition to current information on channels with signals, channels which have been closed down, for example, are not removed from the current channel information. This causes a problem that when the channel up/down key is pressed, the television may be tuned to the closed down channels. Thus, a digital broadcasting receiver which solves such problems has been proposed (see for example, Japanese Laid-Open Publication No. 2004-186975).

The digital broadcasting receiver includes means for storing new channel information from a new channel search while maintaining a registration state of current channel information when there is a difference between the current channel information and the new channel information, means for displaying the channel information which shows the difference on a screen, and means for allowing modification of the registration content of the current channel information based on the new channel information by a user manipulation on the screen. With such a structure, the registration content of the current channel information can be modified based on the new channel information by a user manipulating the channel information which shows the difference on the screen. Thus, the new channel information can be registered with the user's choice being reflected.

Even though the channel information with signal is constantly updated to the latest information, when the user turns on the power of the receiver late at night or early in the morning, if the channel being selected is a channel which was selected when the power was turned off most recently and is not in a broadcasting time, no video is displayed on the monitor screen even though the channel which can be tuned is selected.

In recent years, more households keep pets in house. Accordingly, a problem that the pet disconnect the antenna terminal of the receiver when it runs in the room occurs. When the antenna terminal is disconnected, of course, no video is displayed on the monitor screen.

Under such circumstance, the user may misunderstand that there is something wrong with the receiver because no video is displayed on the screen even though video was displayed when the power was turned off most recently. Such a misunderstanding arises quite often, particularly in the US market. In fact, a lot of users call a customer support center for help because of this misunderstanding and, sometimes, even return the products although nothing is wrong with the products.

An object of the present invention is to solve such problems by providing a broadcasting receiver which prevents such a misunderstanding as far as possible by instructing the users about measures to be taken when a selected channel is not displayed when the power is turned on.

This invention addresses these needs in the art as well as other needs, which will become apparent to those skilled in the art from this disclosure.

### SUMMARY OF THE INVENTION

In order to solve the above described problems, a broadcasting receiver of the present invention includes a tuning section and a control section. The tuning section receives a broadcasting signal corresponding to a selected channel. The control section selects a channel selected when the power was turned off most recently, if the power is turned on, and displays measures to be taken to a user when there is no broadcasting signal on the selected channel. The measures to be displayed include at least one of a channel switching instruction, an antenna terminal connection confirmation instruction, and an auto preset performing instruction. Further, the control section again selects a channel after the user performs any of the measures in accordance with the displayed measures. Displaying the measures is stopped when the broadcasting signal is found on the selected channel as a result of the channel selection. Whether there is a broadcasting signal or not on the selected channel is determined based on a presence/absence of a synchronization signal.

As described above, a situation where the user turns on the power of the receiver late at night or early in the morning but no video is displayed on the monitor screen even though the channel that can be tuned is selected because the channel selected when the power was turned off most recently is not in a broadcasting time may occur in daily use. However, such a situation occurs because the selected channel happens to be not broadcasting at that time. It is highly probable that a broadcasting signal can be received when the tuner section is switched to another channel. In such a case, if the measures are displayed on the monitor screen, the user can switch the channel in accordance with “Change channel” instruction among the displayed measures, for example, and video is displayed on the monitor screen. In this way, it becomes possible to prevent the user from misunderstanding that there is something wrong with the receiver. This can save time and effort of users calling a customer support center because of a misunderstanding, and also can avoid users returning the products.

According to a broadcasting receiver of the present invention, the control section displays one measure from a plurality of preset measures in accordance with a predetermined order, selects a channel again after the measure is carried out, and displays the next one measure in accordance with the order if there is no broadcasting signal on the selected channel until it is determined that there is a broadcasting signal. The measure to be displayed is any one of a channel switching instruction, an antenna terminal connection confirmation instruction, an auto preset performing instruction, and customer support center calling instruction.

According to the present invention, by sequentially displaying the plurality of measures on the monitor screen one by one in the predetermined order, and the user sequentially performing in accordance with the displayed measures, the user is guided so that a video is displayed on the monitor screen. In this way, it becomes possible to prevent the user from misunderstanding that there is something wrong with the receiver. This can save time and effort of users calling a customer support center because of a misunderstanding, and also can avoid users returning the products.

According to a broadcasting receiver of the present invention, the broadcasting receiver further includes a storage section. The storage section sequentially stores a measure performed by amuser as a history when a broadcasting signal is found on a selected channel after the user performs the measure. The control section displays one measure from the plurality of measures in a descending order of the numbers of times of use of the measures which are stored in the storage section. Further, the control section displays the one measure with the largest number of times of use from the plurality of the measures, which are a channel switching instruction, an antenna terminal connection confirmation instruction, and an auto preset performing instruction in accordance with the history stored in the storage section. The control section selects a channel again after the one measure is carried out, and displays another measure with the next largest number of times of use in accordance with the history if there is no broadcasting signal on the selected channel. By employing the descending order of the numbers of times of use of the measures as the order for display, a video is displayed on the monitor screen more quickly.

According to a broadcasting receiver of the present invention, the broadcasting receiver further includes a storage section. The storage section stores a measure performed by a user as the most recently used measure in the past when a broadcasting signal is found on a selected channel after the user performs the measure. The control section selects a channel selected when the power was turned off most recently, if the power is turned on, and displays the most recently used measure in the past first. The measure is stored in the storage section when it is determined that there is no broadcasting signal on the selected channel.

In view of the usage environment of the users, a situation where video is not displayed when the power is turned on often occur under similar conditions. This means that the current situation is likely to be caused by similar reasons as the last time. Thus, by displaying the measure used most recently in the past first; in the order of display, a video is displayed on the monitor screen more quickly.

According to a broadcasting receiver of the present invention, the broadcasting receiver further includes a storage section. The storage section stores an operation immediately before the power was turned off. The control section selects a channel selected when the power was turned off most recently, if the power is turned on, and displays the measures in a preset order in accordance with the operation which is stored in the storage section when it is determined that there is no broadcasting signal on the selected channel.

By taking the operation immediately before the power was turned off into consideration, the reason why a video is not displayed is estimated to some extent. Thus, by determining the order for display based on the operation immediately before the power was turned off, a video is displayed on the monitor screen more quickly.

According to a broadcasting receiver of the present invention, the control section repeats displaying the one measure by a preset number of times (for example, five times) when the one measure is the channel switching instruction, and then displays the next one measure.

When the channel is switched, it is probable that the next channel is also not broadcasting at that time. Thus, by switching the channels for a few times, video may be displayed on the monitor screen. Therefore, by displaying the channel switching instruction five times in a row at the maximum, thereby providing the user with opportunity to perform channel switching operations five times at the maximum, a video is sure to be displayed on the monitor screen.

According to a broadcasting receiver of the present invention, the control section stops displaying the measures when the broadcasting signal is found on the selected channel as a result of the channel selection. Further, the control section determines a presence/absence of the broadcasting signal based on a presence/absence of a synchronization signal.

According to a broadcasting receiver of the present invention, measures to be taken are displayed to a user if there is no broadcasting signal on a selected channel when the power is turned on. Thus, if the user switches the channel in accordance with the channel switching instruction among the displayed measures, for example, video is displayed on the monitor screen. In this way, it becomes possible to prevent the user from misunderstanding that there is something wrong with the receiver. This can save time and effort of users calling a customer support center because of a misunderstanding, and also can avoid users returning the products.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram showing an electric structure of a television receiver according to an embodiment of the broadcasting receiver of the present invention;

FIG. 2 is a diagram illustrating an AFT voltage characteristic;

FIG. 3 is a schematic diagram illustrating how data on channel positions are stored;

FIG. 4 is a flow diagram showing a process operation of Example 1 for displaying measures on a monitor screen if there is no broadcasting signal for a channel selected when the power is turned on;

FIGS. 5 is a flow diagram showing a process operation of Example 2 for displaying measures on a monitor screen if there is no broadcasting signal for a channel selected when the power is turned on;

FIG. 6 is a flow diagram showing a process operation for counting the number of times of use for measures which corresponds to Example 3;

FIG. 7 is a flow diagram showing a process operation of Example 3 for displaying measures on a monitor screen if there is no broadcasting signal for a channel selected when the power is turned on;

FIG. 8 is a diagram illustrating an example of data on the number of times of use in the past for each of the measures which is stored in a predetermined area of an EEPROM;

FIG. 9 is a flow diagram showing a process operation of Example 4 for displaying measures on a monitor screen if there is no broadcasting signal for a channel selected when the power is turned on;

FIG. 10 is a diagram illustrating an example of data on a displaying order for measures which are previously determined in accordance with an operation and is stored in EEPROM; and

FIG. 11 is a flow diagram showing a process operation of Example 5 for displaying measures on a monitor screen if there is no broadcasting signal for a channel selected when the power is turned on.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

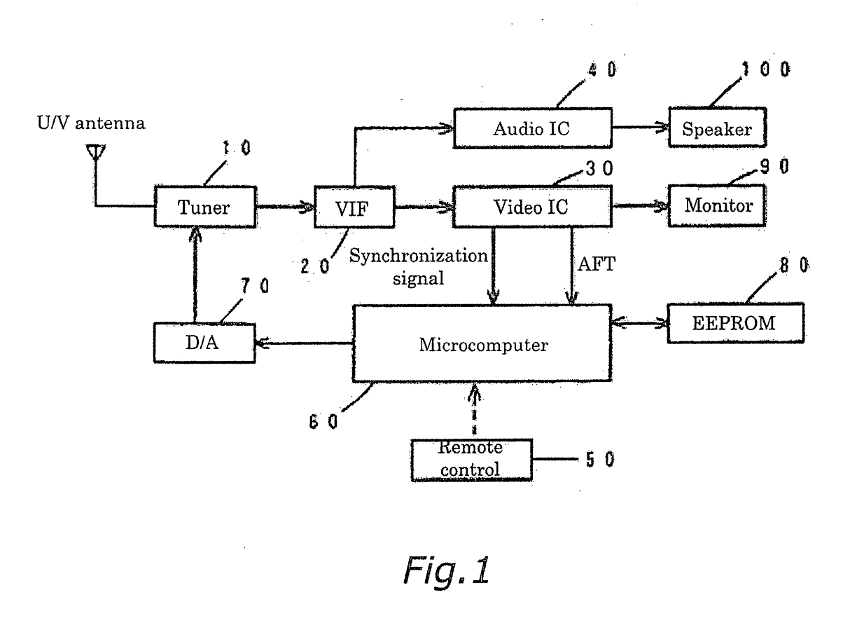

FIG. 1 is a block diagram showing an electric structure of a television receiver according to an embodiment of the broadcasting receiver of the present invention.

The television receiver includes a tuner 10, a VIF (Video Intermediate Frequency) circuit 20, a video IC 30, an audio IC 40, a remote control 50, a microcomputer 60, a D/A converter 70, and an EEPROM 80.

The tuner 10 receives a signal that corresponds to a frequency of a desired channel via a U/V antenna. The tuner 10 selects only a required signal to subject it to high-frequency amplification and outputs the signal. The tuner 10 employs a voltage synthesizer. Thus, it synchronizes with the frequency of the desired channel based on input of a tuning voltage and a band switch voltage. In the present embodiment, the receiver receives television airwaves. However, the receiver may be applied to other types of broadcasting such as cable television broadcasting.

The signal output from the tuner 10 is subjected to video intermediate frequency amplification by the VIF circuit 20, and is output to the video IC 30.

Meanwhile an audio intermediate frequency signal is present as a frequency-modulated signal which is 4.5 MHz lower than 58.75 MHz which is the frequency of the video intermediate frequency signal. When the signal, after being subjected to the intermediate frequency amplification, is detected by a diode (not shown), it is extracted as a second audio intermediate frequency signal of 4.5 MHz. The extracted second audio intermediate frequency signal is subjected to frequency modulation detection, and is amplified as necessary. Then, the signal is output from the speaker 100. In this embodiment, the tuner 10 and the VIF circuit 20, as a whole, constitute a tuning section of the present invention.

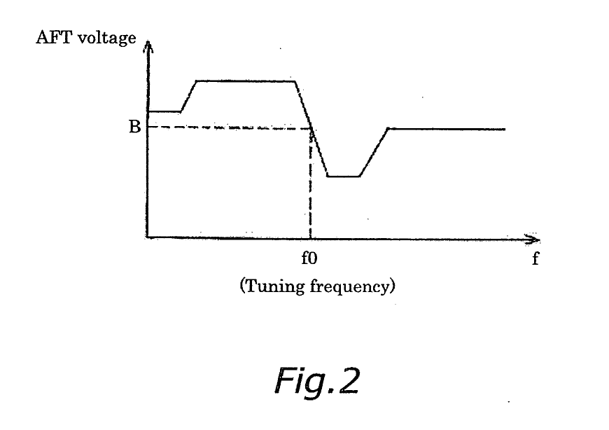

On the other hand, the video IC 30 performs video detection on the signal after video intermediate frequency amplification which has been input as described above. The video IC 30 performs signal processing such as synchronizing separation, color reproduction, and the like, and outputs the signal to the monitor 90 as a video signal. Further, the video IC 30 includes an AFT circuit (not shown). The AFT circuit generates an AFT (error) voltage which corresponds to a shift between the frequency of an actual video carrier wave and a reference frequency. As shown in FIG. 2, the AFT voltage has a voltage characteristic which is inversely S-shaped with the tuning frequency f0 as a center. Specifically, when the frequency of the actual video carrier wave and the reference frequency match each other, the AFT voltage becomes B voltage. When they are slightly shifted from each other, the voltage shows a tendency of monotonous increase or a monotonous decrease depending upon the direction of the shift. When they differ from each other largely, the voltage saturates on the upper side and the lower side of the B voltage and becomes constant. Therefore, if the actual AFT voltage is detected and compared with the B voltage, the amount and the direction of the shift can be known.

In the television receiver of the present embodiment, various manipulations can be performed using the remote control 50. The remote control 50 has an operational panel (not shown). The operational panel has operation keys that include a power key, channel keys, channel up/down keys, volume keys and the like. When any of the operation keys is pressed, a corresponding infrared radiation remote control signal is sent. The main part of the television receiver receives the infrared radiation remote control signal via an infrared radiation remote control signal light receiving section (not shown). The signal is detected by the microcomputer 60, and a corresponding process is performed.

For example, for instructing a selected channel of the tuner 10, a channel key is pressed or a channel up/down key is pressed. Then, the microcomputer 60 detects the signal and outputs digital coded tuning voltage data to cause the tuner 10 to receive the indicated channel (hereinafter referred to as a “tuning operation”). The tuning voltage data is first converted into an analog tuning voltage at the D/A converter 70, and is supplied to the tuner 10. The band switch voltage is also supplied at this time.

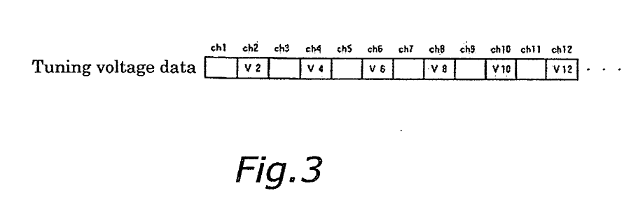

The tuner 10 according to the present invention employs the voltage synthesizer. Thus, the tuning voltage data has to be preset. Specifically, an auto preset process of allocating desired tuning voltage data to channel numbers of “1” to “12” and storing them into the EEPROM 8 is previously performed. When there is an instruction to receive a channel, the microcomputer 60 retrieves and sends out the corresponding tuning voltage data. More specifically, a memory space of the EEPROM 80 is divided into channel positions corresponding to the channel numbers as shown in FIG. 3. The voltage data can be allocated to and stored in each of the channel positions.

For actual allocation, a predetermined auto preset process is performed by the microcomputer 60 and the data is stored. In such a case, a synchronization signal separated at the video IC 30 and the AFT voltage are retrieved by the microcomputer 60. A tuning frequency of the tuner 10 is changed substantially continuously. When a tuning point (tuning frequency) where there is a synchronizing signal and the AFT voltage is the smallest is found, it is allocated to a predetermined channel number and is stored.

With the above-described structure according to the present embodiment, when the power is turned on by pressing the power key of the remote control 50, the microcomputer 60 performs a tuning operation for the channel selected when the power was turned off most recently. If there is no broadcasting signal on the selected channel, the measures to be taken are displayed to the user.

Herein, three measures are prepared as the measures to be displayed: “Switch channel” instruction; “Confirm connection of antenna terminal” instruction; and “Carry out auto preset” instruction. The data on the three measures are stored in a predetermined area of the EEPROM 80.

Hereinafter, an operation for displaying the measures by the microcomputer 60 when there is no broadcasting signal on the selected channel will be described specifically with reference to the examples.

### EXAMPLE 1

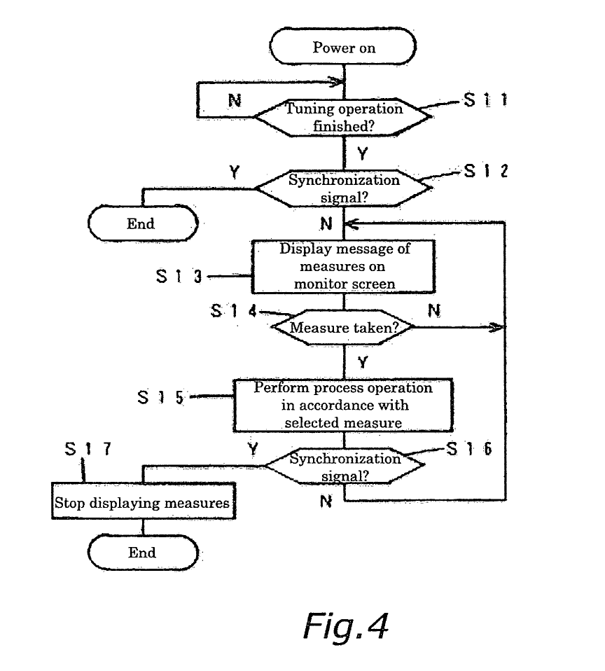

Example 1 is an example in which all the measures stored in the EEPROM 80 are displayed at once if there is no broadcasting signal on the selected channel when the power is turned on. Hereinafter, the example will be described with reference to FIG. 4.

When the power is turned on by pressing the power key of the remote control 50, the microcomputer 60 performs a tuning operation for the channel selected when the power was turned off most recently (step S11). The microcomputer 60 determines whether there is a broadcasting signal on the selected channel based on a presence/absence of the synchronization signal (step S12). When it is determined that there is no broadcasting signal on the selected channel (determined No at step S12), the microcomputer 60 reads out the measures stored in the EEPROM 80, and displays all the measures on the screen of the monitor 90 via the video IC 30 (step S13).

When the user watching the monitor screen selects one from the displayed measures and carries out (determined Yes at step S14), the microcomputer 60 performs a process operation in accordance with the selected measure (step S15). More specifically, for example, when the user selects the “Switch channel” instruction from the measures displayed on the monitor screen and manipulates, for example, the channel up/down key of the remote control 50, the microcomputer 60 performs a channel tuning operation in accordance with the manipulation of the channel.

Then, the microcomputer 60 determines whether there is a broadcasting signal on the selected channel based on a presence/absence of the synchronization signal (step S16). When it is determined that there is no broadcasting signal on the selected channel (determined No at step S16), the process returns to step S13, and all the measures are again displayed on the screen of the monitor 90. On the other hand, when it is determined that there is a broadcasting signal on the selected channel (determined Yes at step S16), the microcomputer 60 stops displaying the measures on the monitor screen (step S17), and finishes the process. This means that it continues receiving this channel.

For example, at step S13, when the user selects the “Confirm connection of antenna terminal” instruction from the displayed measures, the user confirms the connection state of the antenna terminal and inserts the antenna terminal into the antenna plug if they are disconnected. Then, when the microcomputer 60 detects that the antenna terminal is connected to the antenna plug (determined Yes at step S14), the microcomputer 60 performs the tuning operation for the channel being selected at the moment (step S15). When it is determined that there is no broadcasting signal on the selected channel (determined No at step S16), the process returns to step S13 and all the measures are again displayed on the screen of the monitor 90. On the other hand, when it is determined that there is a broadcasting signal on the selected channel (determined Yes at step S16), the microcomputer 60 stops displaying the measures on the monitor screen (step S17), and finishes the process. This means that it continues receiving this channel. At step S14, the microcomputer 60 may detect the antenna connection based on a signal from an antenna connection detection unit (not shown), which is a mechanical switch that can output the signal when the antenna terminal is connected to the antenna plug.

For example, at step S13, when the user selects the “Carry out auto preset” instruction from the displayed measures and directs to perform the auto preset operation (determined Yes at step S14), the microcomputer 60 performs the auto preset operation and displays the first channel on the monitor screen as a selected channel after the operation (step S15). As a result, it is determined that there is a broadcasting signal on the selected channel at step S16. The microcomputer 60 stops displaying the measures on the monitor screen (step S17), and finishes the process. This means that it continues receiving this channel.

### EXAMPLE 2

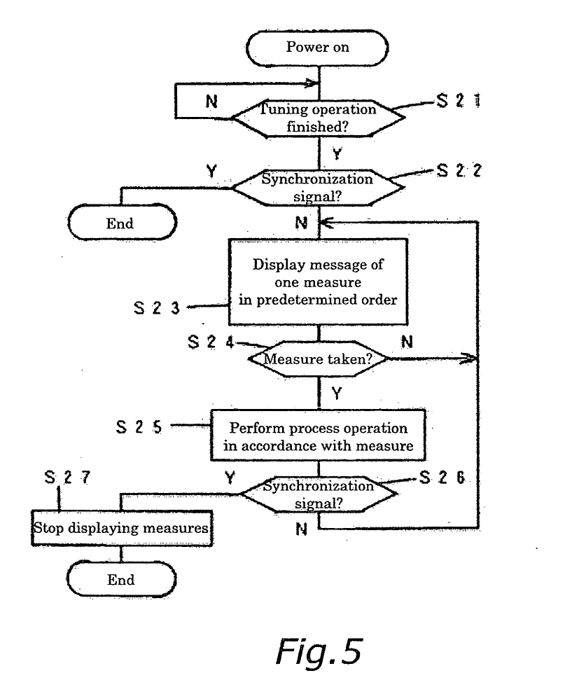

Example 2 is an example in which a plurality of the measures stored in the EEPROM 80 are displayed one by one in a predetermined order if there is no broadcasting signal on the selected channel when the power is turned on. Hereinafter, the example will be described with reference to FIG. 5.

When the power is turned on by pressing the power key of the remote control 50, the microcomputer 60 performs a tuning operation for the channel selected when the power was turned off most recently (step S21). The microcomputer 60 determines whether there is a broadcasting signal on the selected channel based on a presence/absence of the synchronization signal (step S22). When it is determined that there is no broadcasting signal on the selected channel (determined No at step S22), the microcomputer 60 reads out the measures stored in the EEPROM 80, and displays the first measure on the screen of the monitor 90 in accordance with the predetermined order (step S23). In Example 2, the order for displaying the measures is set to be the following order: “Switch channel” instruction; “Confirm connection of antenna terminal” instruction; and “Carry out auto preset” instruction. Thus, at this time, the first measure, “Switch channel” instruction, is displayed on the monitor screen.

When the user carries out the displayed measure (determined Yes at step S24), the microcomputer 60 performs a process operation in accordance with the measure (step S25). More specifically, for example, when the user follows the “Switch channel” instruction displayed on the screen and manipulates, for example, the channel up/down key of the remote control 50, the microcomputer 60 performs a channel tuning operation in accordance with the manipulation of the channel.

Then, the microcomputer 60 determines whether there is a broadcasting signal on the selected channel based on a presence/absence of the synchronization signal (step S26). When it is determined that there is a broadcasting signal on the selected channel (determined Yes at step S26), the microcomputer 60 stops displaying the measure on the monitor screen (step S27), and finishes the process. This means that it continues receiving this channel. On the other hand, when it is determined that there is no broadcasting signal on the selected channel (determined No at step S26), the process returns to step S23, and the next measure is displayed on the screen of the monitor 90 in accordance with the predetermined order.

When the user follows the “Confirm connection of antenna terminal” displayed on the screen and confirms the connection state of the antenna terminal, the user inserts the antenna terminal into the antenna plug if they are disconnected. Then, when the microcomputer 60 detects that the antenna terminal is connected to the antenna plug (determined Yes at step S24), the microcomputer 60 performs the tuning operation for the channel being selected at the moment (step S25). When it is determined that there is a broadcasting signal on the selected channel (determined Yes at step S26), the microcomputer 60 stops displaying the measure on the monitor screen (step S27), and finishes the process. This means that it continues receiving this channel. On the other hand, when it is determined that there is no broadcasting signal on the selected channel (determined No at step S26), the process returns to step S23 and the next measure is displayed on the screen of the monitor 90 in accordance with the predetermined order. This means that the third measure, the “Carry out auto preset” instruction, is displayed on the screen. At step S24, the microcomputer 60 may detect the antenna connection based on a signal from the antenna connection detection unit (not shown).

When the user follows the “Carry out auto preset” instruction displayed on the screen and directs to perform the auto preset operation (determined Yes at step S24), the microcomputer 60 performs the auto preset operation and displays the first channel on the monitor screen as a selected channel after the operation (step S25). As a result, it is determined that there is a broadcasting signal on the selected channel at step S26. The microcomputer 60 stops displaying the measure on the monitor screen (step S27), and finishes the process. This means that it continues receiving this channel.

### EXAMPLE 3

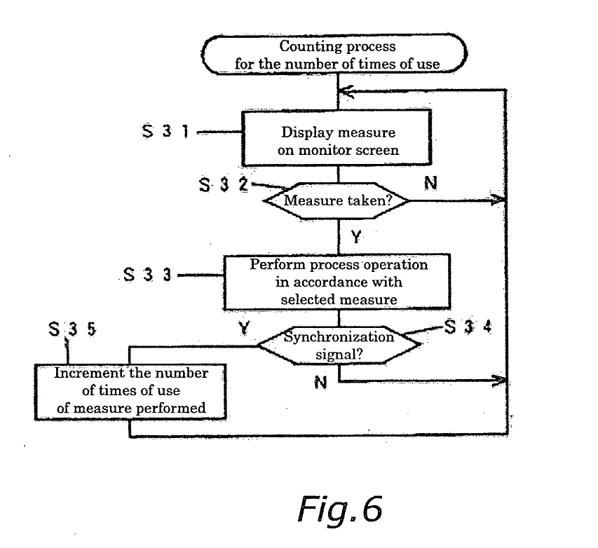

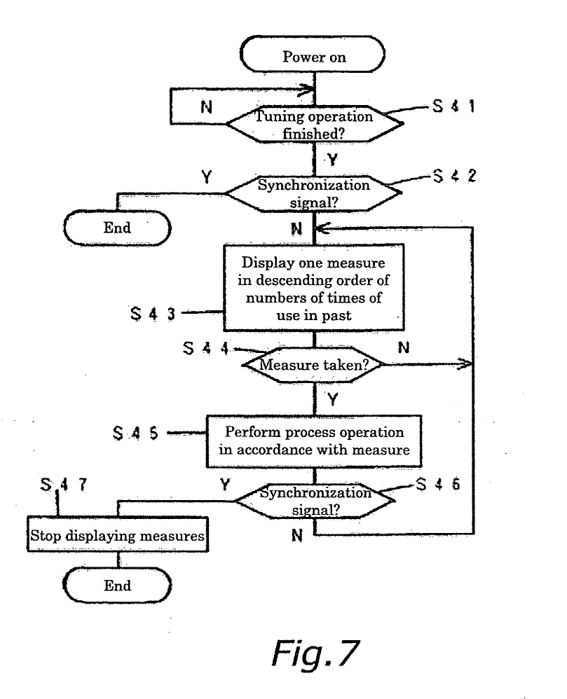

Example 3 is an example in which a plurality of the measures stored in the EEPROM 80 are displayed one by one in a descending order of the number of times of use in the past if there is no broadcasting signal on the selected channel when the power is turned on. In Example 3, data on the number of times of use in the past for each of the measures are stored in a predetermined area of the EEPROM 80. Hereinafter, the example will be described with reference to flow diagrams shown in FIGS. 6 and 7.

FIG. 6 is a flow diagram showing a process for counting the number of times of use in the past for each of the measures and storing them into the EEPROM 80.

While a measure is displayed on the monitor screen (step S31), the microcomputer 60 determines whether the measure is selected by the user or not (step S32). When the measure is carried out by the user (determined Yes at step S32), the microcomputer 60 performs a process operation in accordance with the measure (step S33). Then, the microcomputer 60 determines whether there is a broadcasting signal on the selected channel based on a presence/absence of the synchronization signal (step S34). When it is determined that there is no broadcasting signal on the selected channel (determined No at step S34), the process returns to step S31. On the other hand, when it is determined that there is a broadcasting signal on the selected channel (determined Yes at step S34), the number of times of use of the measure carried out at step S33 is increased by one and stored in a predetermined area of the EEPROM 80. By repeating such a process every time when a measure is carried out, the predetermined area of the EEPROM 80 stores the number of times of use in the past for each of the measures. If the most recent data for a certain period of time (for example, the last three months) is kept as the data on the numbers of times of use, the latest data on the numbers of times of use can always be stored.

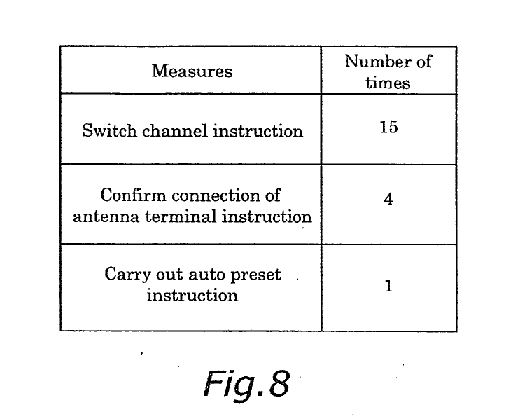

FIG. 8 is a diagram showing an example of the number of times of use in the past for each of the measures stored in the predetermined area of the EEPROM 80. In this example, the number of times of use in the past are, respectively, fifteen times for the “Switch channel” instruction, four times for the “Confirm connection of antenna terminal” instruction, and once for the “Carry out auto preset” instruction.

Next, a process for displaying measures by using the number of times of use in the past for each of the measures stored as described above if there is no broadcasting signal on the selected channel when the power is turned on will be described. The process will be described with reference to a flow diagram shown in FIG. 7.

When the power is turned on by pressing the power key of the remote control 50, the microcomputer 60 performs a tuning operation for the channel selected when the power was turned off most recently (step S41). The microcomputer 60 determines whether there is a broadcasting signal on the selected channel based on a presence/absence of the synchronization signal (step S42). When it is determined that there is no broadcasting signal on the selected channel (determined No at step S42), the microcomputer 60 reads out the data for the measures and the data for the numbers of times of use stored in the EEPROM 80, and displays the first measure on the screen of the monitor 90 in accordance with the descending order of the number of times of use (step S43). In Example 3, as shown in FIG. 8, the “Switch channel” instruction has the largest number of use in the past. Thus, the “Switch channel” instruction is displayed on the monitor screen.

When the user carries out the displayed measure (determined Yes at step S44), the microcomputer 60 performs a process operation in accordance with the measure (step S45). More specifically, for example, when the user follows the “Switch channel” instruction displayed on the screen and manipulates, for example, the channel up/down key of the remote control 50, the microcomputer 60 performs a channel tuning operation in accordance with the manipulation of the channel.

Then, the microcomputer 60 determines whether there is a broadcasting signal on the selected channel based on a presence/absence of the synchronization signal (step S46). When it is determined that there is a broadcasting signal on the selected channel (determined Yes at step S46), the microcomputer 60 stops displaying the measure on the monitor screen (step S47), and finishes the process. This means that it continues receiving this channel. On the other hand, when it is determined that there is no broadcasting signal on the selected channel (determined No at step S46), the process returns to step S43, and the measure with the next largest number is displayed on the screen of the monitor 90 in accordance with the descending order of the numbers of use. This means that the “Confirm connection of antenna terminal” instruction is displayed on the screen.

When the user follows the “Confirm connection of antenna terminal” instruction displayed on the screen and confirms the connection state of the antenna terminal, the user inserts the antenna terminal into the antenna plug if they are disconnected. Then, when the microcomputer 60 detects that the antenna terminal is connected to the antenna plug (determined Yes at step S44), the microcomputer 60 performs the tuning operation for the channel being selected at the moment (step S45). When it is determined that there is a broadcasting signal on the selected channel (determined Yes at step S46), the microcomputer 60 stops displaying the measure on the monitor screen (step S47), and finishes the process. This means that it continues receiving this channel. On the other hand, when it is determined that there is no broadcasting signal on the selected channel (determined No at step S46), the process returns to step S43 and the measure with the next largest number is displayed on the screen of the monitor 90 in accordance with the descending order of the numbers of use. This means that the “Carry out auto preset” instruction is displayed on the screen. At step S44, the microcomputer 60 may detect the antenna connection based on a signal from the antenna connection detection unit (not shown).

When the user follows the “Carry out auto preset” instruction displayed on the screen (determined Yes at step S44), the microcomputer 60 performs the auto preset operation and displays the first channel on the monitor screen as a selected channel after the operation (step S45). As a result, it is determined that there is a broadcasting signal on the selected channel at step S46. The microcomputer 60 stops displaying the measure on the monitor screen (step S47), and finishes the process. This means that it continues receiving this channel.

### EXAMPLE 4

Example 4 is an example in which the most recently used measure in the past is displayed if there is no broadcasting signal on the selected channel when the power is turned on. In Example 4, data on the most recently used measure in the past is stored in an internal memory (not shown) of the microcomputer 60. A process for storing the data on the most recently used measure in the past is almost the same as the process for storing the number of times of use in the past for each of the measures in the predetermined area of the EEPROM 80 described in Example 3 with reference to FIG. 6. The only difference is the process at step S35. Specifically, in Example 4, instead of the process of step S35 when it is determined that there is a synchronization signal, a process of storing (in this example, overwriting) data indicating the type of the measure carried out at step S32 into the internal memory of the microcomputer 60 is performed. In this way, the data indicating the type of the most recently used measure in the past is always stored and updated in the internal memory of the microcomputer 60.

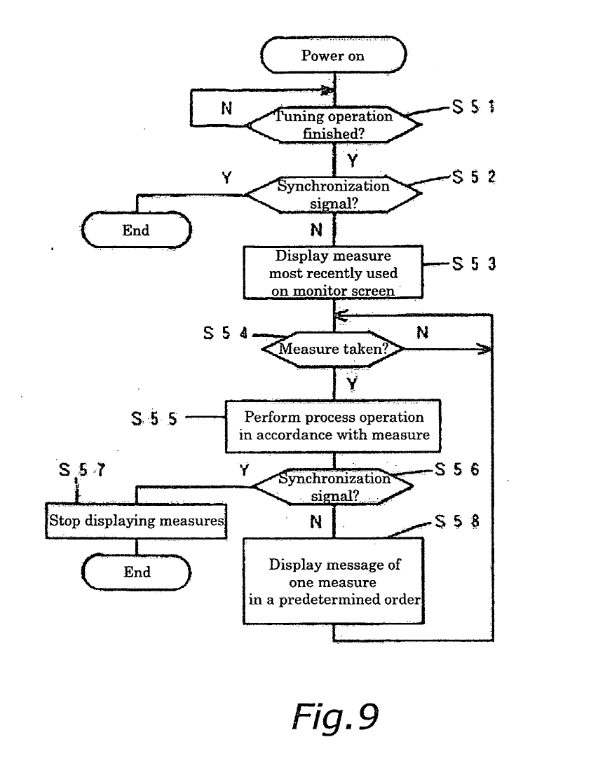

Next, a process for displaying a measure by using the data indicating the type of the most recently used measure in the past stored as described above if there is no broadcasting signal on the selected channel when the power is turned on will be described. The process will be described with reference to a flow diagram shown in FIG. 9.

When the power is turned on by pressing the power key of the remote control 50, the microcomputer 60 performs a tuning operation for the channel selected when the power was turned off most recently (step S51). The microcomputer 60 determines whether there is a broadcasting signal on the selected channel based on a presence/absence of the synchronization signal (step S52). When it is determined that there is no broadcasting signal on the selected channel (determined No at step S52), the microcomputer 60 displays the most recently used measure in the past on the screen of the monitor 90 based on the data indicating the type of the most recently used measure in the past which is stored in the internal memory (step S53). If the most recently used measure in the past is the “Switch channel” instruction, for example, the “Switch channel” instruction is displayed on the monitor screen.

When the user carries out the displayed measure (determined Yes at step S54), the microcomputer 60 performs a process operation in accordance with the measure (step S55). More specifically, for example, when the user follows the “Switch channel” instruction displayed on the screen and manipulates, for example, the channel up/down key of the remote control 50, the microcomputer 60 performs a channel tuning operation in accordance with the manipulation of the channel.

Then, the microcomputer 60 determines whether there is a broadcasting signal on the selected channel based on a presence/absence of the synchronization signal (step S56). When it is determined that there is a broadcasting signal on the selected channel (determined Yes at step S56), the microcomputer 60 stops displaying the measure on the monitor screen (step S57), and finishes the process. This means that it continues receiving this channel. On the other hand, when it is determined that there is no broadcasting signal on the selected channel (determined No at step S56), and the next measure is displayed on the screen of the monitor 90 in accordance with the predetermined display order (step S58). For example, the “Confirm connection of antenna terminal” is displayed.

When the user follows the “Confirm connection of antenna terminal” instruction displayed on the screen and confirms the connection state of the antenna terminal, the user inserts the antenna terminal into the antenna plug if they are disconnected. Then, when the microcomputer 60 detects that the antenna terminal is connected to the antenna plug (determined Yes at step S54), the microcomputer 60 performs the tuning operation for the channel being selected at the moment (step S55). When it is determined that there is a broadcasting signal on the selected channel (determined Yes at step S56), the microcomputer 60 stops displaying the measure on the monitor screen (step S57), and finishes the process. This means that it continues receiving this channel. On the other hand, when it is determined that there is no broadcasting signal on the selected channel (determined No at step S56), the process moves to step S58 and the next measure is displayed on the screen of the monitor 90 in accordance with the predetermined order. This means that the “Carry out auto preset” instruction is displayed on the screen. At step S54, the microcomputer 60 may detect the antenna connection based on a signal from the antenna connection detection unit (not shown).

When the user follows the “Carry out auto preset” instruction displayed on the screen and directs to perform the auto preset operation (determined Yes at step S54), the microcomputer 60 performs the auto preset operation and displays the first channel on the monitor screen as a selected channel after the operation (step S55). As a result, it is determined that there is a broadcasting signal on the selected channel at step S56. The microcomputer 60 stops displaying the measure on the monitor screen (step S57), and finishes the process. This means that it continues receiving this channel.

### EXAMPLE 5

Example 5 is an example in which the measure is displayed in accordance with the order previously determined so as to correspond to the operation immediately before the power was turned off (hereinafter referred to as a “previous operation”) if there is no broadcasting signal on the selected channel when the power is turned on. In Example 5, the data on the previous operation is stored in the internal memory (not shown) of the microcomputer 60. The data on the order for displaying the measures which is previously determined so as to correspond to the operation is stored in a predetermined area of the EEPROM 80.

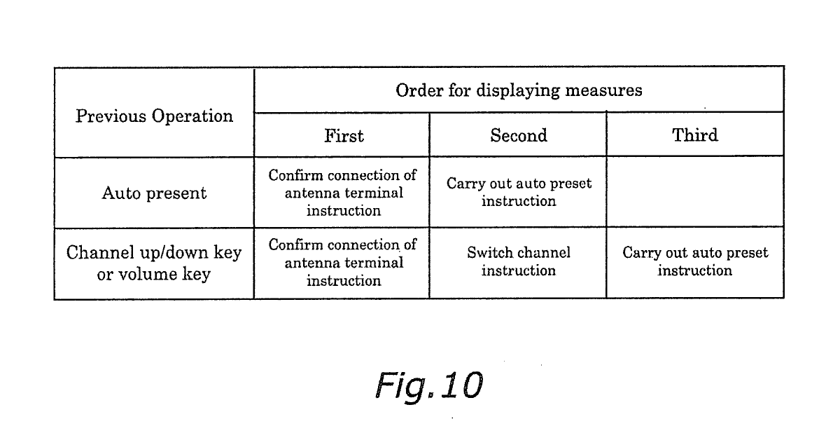

FIG. 10 shows an example of the data of the order for displaying the measure which is previously determined so as to correspond to the operation and is stored in the EEPROM 80. In this example, the operations immediately before the power was turned off are “auto preset” operation and “channel up/down key or volume key” operation. These two types of operations respectively represent an operation in initial setting and an operation in normal use. However, these are only examples, and the operations are not limited to these two types.

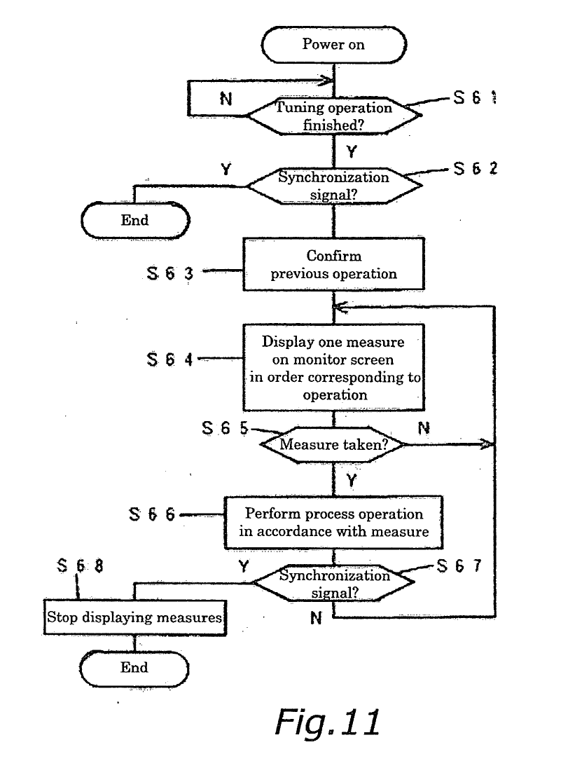

Next, a process for displaying measures by using the previous operation which is stored as described above if there is no broadcasting signal on the selected channel when the power is turned on will be described. The process will be described with reference to a flow diagram shown in FIG. 11.

When the power is turned on by pressing the power key of the remote control 50, the microcomputer 60 performs a tuning operation for the channel selected when the power was turned off most recently (step S61). The microcomputer 60 determines whether there is a broadcasting signal on the selected channel based on a presence/absence of the synchronization signal (step S62). When it is determined that there is no broadcasting signal on the selected channel (determined No at step S62), the data on the previous operation which is stored in the internal memory of the microcomputer 60 is read out (step S63). Next, the data on the order for displaying the measures which is previously determined so as to correspond to the previous operation is read out from the EEPROM 80, and the first measure is displayed on the screen of the monitor 90 in accordance with the predetermined order (step S64). In Example 5, the previous operation is “channel up/down key or volume key” operation. In such a case, the order for displaying the measures is set to be the following order: “Confirm connection of antenna terminal” instruction; “Switch channel” instruction; and “Carry out auto preset” instruction. Thus, at this time, the first measure, “Confirm connection of antenna terminal” instruction, is displayed on the monitor screen.

When the user carries out the displayed measure (determined Yes at step S65), the microcomputer 60 performs a process operation in accordance with the measure (step S66). More specifically, when the user follows the “Confirm connection of antenna terminal” instruction displayed on the screen and confirms the connection state of the antenna terminal, the user inserts the antenna terminal into the antenna plug if they are disconnected. Then, when the microcomputer 60 detects that the antenna terminal is connected to the antenna plug (determined Yes at step S65), the microcomputer 60 performs the tuning operation for the channel being selected at the moment (step S66).

Then, the microcomputer 60 determines whether there is a broadcasting signal on the selected channel based on a presence/absence of the synchronization signal (step S67). When it is determined that there is a broadcasting signal on the selected channel (determined Yes at step S67), the microcomputer 60 stops displaying the measure on the monitor screen (step S68), and finishes the process. This means that it continues receiving this channel. On the other hand, when it is determined that there is no broadcasting signal on the selected channel (determined No at step S67), the process returns to step S64, and the next measure is displayed on the screen of the monitor 90 in accordance with the predetermined order. This means that, the second measure, “Switch channel” instruction is displayed. At step S65, the microcomputer 60 may detect the antenna connection based on a signal from the antenna connection detection unit (not shown).

When the user follows the “Switch channel” instruction displayed on the screen and manipulates, for example, the channel up/down key of the remote control 50, the microcomputer 60 performs a channel tuning operation in accordance with the manipulation of the channel. When it is determined that there is a broadcasting signal on the selected channel (determined Yes at step S67), the microcomputer 60 stops displaying the measure on the monitor screen (step S68), and finishes the process. This means that it continues receiving this channel. On the other hand, when it is determined that there is no broadcasting signal on the selected channel (determined No at step S68), the process returns to step S64 and the next measure is displayed on the screen of the monitor 90 in accordance with the predetermined order. This means that the third measure, the “Carry out auto preset” instruction, is displayed on the screen.

When the user follows the “Carry out auto preset” instruction displayed on the screen (determined Yes at step S65), the microcomputer 60 performs the auto preset operation and displays the first channel on the monitor screen as a selected channel after the operation (step S66). As a result, it is determined that there is a broadcasting signal on the selected channel at step S67. The microcomputer 60 stops displaying the measure on the monitor screen (step S68), and finishes the process. This means that it continues receiving this channel.

In the above Examples 1 through 5, when the user performs the channel switching operation once following the measure “Switch channel” instruction, and video is still not displayed, the next measure (for example, “Confirm connection of antenna terminal” instruction and the like) is displayed. However, the “Switch channel” instruction may be repeated a plurality of times.

When the channel is switched, it is probable that the next channel is also not broadcasting at that time. Thus, by switching the channels for a few times, video may be displayed on the monitor screen. Therefore, by displaying the “Switch channel” instruction five times in a row at the maximum, thereby providing the user with opportunity to perform channel switching operations five times at the maximum, video is sure to be displayed on the monitor screen.

It will be apparent to one of skill in the art from this disclosure that the broadcasting receiver of the present invention may be provided not only in the television receiver but also in a digital versatile disc (DVD) recorder and the like.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A broadcasting receiver for receiving a broadcasting signal, comprising:
a tuning section configured for receiving a broadcasting signal corresponding to a selected channel; and
a control section configured for selecting a channel selected when the power was turned off most recently when the power is turned on, and for displaying a plurality of measures to a user when there is no broadcasting signal on the selected channel.

2. The broadcasting receiver according to claim 1, wherein
the measures to be displayed include at least one of a channel switching instruction, an antenna terminal connection confirmation instruction, and an auto preset performing instruction.

3. The broadcasting receiver according to claim 1, wherein
the control section again selects a channel after the user performs any of the measures in accordance with the displayed measures.

4. The broadcasting receiver according to claim 3, wherein
the control section stops displaying the measures when the broadcasting signal is found on the selected channel as a result of the channel selection.

5. The broadcasting receiver according to claim 1, wherein
the control section determines a presence/absence of the broadcasting signal based on a presence/absence of a synchronization signal.

6. The broadcasting receiver according to claim 1, wherein
the control section displays one of the measures in accordance with a predetermined order, selects a channel again after the measure is carried out, and displays the next measure in accordance with the predetermined order if there is no broadcasting signal on the selected channel until it is determined that there is a broadcasting signal.

7. The broadcasting receiver according to claim 6, wherein
the measure to be displayed is any one of a channel switching instruction, an antenna terminal connection confirmation instruction, and an auto preset performing instruction.

8. The broadcasting receiver according to claim 6, further comprising
a storage section for sequentially storing a measure performed by a user as a history when a broadcasting signal is found on a selected channel after the user performs the measure,
the control section displaying one measure from the measures in a descending order of the number of times of use of the measures which are stored in the storage section.

9. The broadcasting receiver according to claim 8, wherein
the control section displays the one measure with the largest number of times of use from the measures in accordance with the history stored in the storage section, selects a channel again after the one measure is carried out, and displays another measure with the next largest number of times of use in accordance with the history if there is no broadcasting signal on the selected channel.

10. The broadcasting receiver according to claim 6, further comprising
a storage section for storing a measure performed by a user as the most recently used measure in the past when a broadcasting signal is found on a selected channel after the user performs the measure,
the control section selecting a channel selected when the power was turned off most recently when the power is turned on, and displaying the most recently used measure in the past first, the measure being stored in the storage section when it is determined that there is no broadcasting signal on the selected channel.

11. The broadcasting receiver according to claim 6, further comprising
a storage section for storing an operation immediately before when the power was turned off,
the control section selecting a channel selected when the power was turned off most recently when the power is turned on, and displaying the measures in a preset order in accordance with the operation which is stored in the storage section when it is determined that there is no broadcasting signal on the selected channel.

12. The broadcasting receiver according to claim 6, wherein
the control section repeats displaying the one measure by a preset number of times when the one measure is the channel switching instruction, and then displays the next one measure.

13. The broadcasting receiver according to claim 6, wherein
the control section stops displaying the measures when the broadcasting signal is found on the selected channel as a result of the channel selection.

14. The broadcasting receiver according to claim 6, wherein
the control section determines a presence/absence of the broadcasting signal based on a presence/absence of a synchronization signal.
